(19) United States
(12) Patent Application Publication
(10) Pub. No.: US 2026/0003766 A1
(43) Pub. Date: Jan. 1, 2026

(54) GENERATIVE AI-ASSISTED AVIONICS SYSTEM AND SOFTWARE REQUIREMENT COMPLETENESS CHECKER

(71) Applicant: Honeywell International Inc., Charlotte, NC (US)

(72) Inventors: Aralakuppe Ramegowda Yogesha, Bangalore (IN); Jayakumar S S, Bangalore (IN); Srikanth Nagaraj, Bangalore (IN); Pradeep Sadananda, Bangalore (IN); Abhishek Alladi, Hyderabad (IN); Durgaprasad Bhogadi, Phoenix, AZ (US)

(73) Assignee: Honeywell International Inc., Charlotte, NC (US)

(21) Appl. No.: 18/804,655

(22) Filed: Aug. 14, 2024

(30) Foreign Application Priority Data
Jun. 28, 2024 (IN) 202411049622

(51) Int. Cl. G06F 11/36; G06N 3/0895

(52) U.S. Cl. CPC G06F 11/3612; G06N 3/0895

(57) ABSTRACT

A system comprises a set of databases in communication with a processor, and a requirements validation AI engine hosted by the processor. The databases comprise software requirements, regulatory guidelines, historical requirements defects, requirements review checklist, and prompts. The AI engine communicates with the databases, and a fine-tuned LLM communicates with the AI engine. A user interface communicates with the AI engine, and a configuration management repository communicates with the user interface. The user interface sends new requirements, from the configuration management repository, with corresponding check instructions to the AI engine, which selects prompts for review, based on types of new requirements and the check instructions. The AI engine sends the prompts and the new requirements to the LLM to review for any defects in the new requirements. The LLM sends a response to the user interface, to report on validity of and any defects in the new requirements.

### CROSS-REFERENCE TO RELATED APPLICATION

This application claims priority to Indian Provisional Patent Application No. 202411049622 filed on Jun. 28, 2024, the contents of which are incorporated herein by reference in their entirety.

### BACKGROUND

Early validation of customer requirement, system and software requirements is crucial for the safety of avionics systems. It helps to identify and correct errors early in the development process before they propagate and become more difficult and expensive to fix. Early validation can also help to reduce development costs and significantly improve customer satisfaction by ensuring that the final product aligns with their expectations and requirements. The adherence to DO-178C is crucial to ensure the safety, reliability, and effectiveness of avionics systems. Bad requirements, on the other hand, can lead to severe implications ranging from safety hazards to financial burdens.

Manual review of the requirement is the commonly used technique to validate customer specification, system and software requirements. While manual reviews offer domain expertise, intuition, and contextual understanding, they are also prone to oversights, especially in large and complex projects.

### SUMMARY

A system comprises at least one processor, and a set of databases in operative communication with the at least one processor. The set of databases comprises a software requirements database, a regulatory guidelines database, a historical requirements defects database, a requirements review checklist database, and a prompt database that includes a respective prompt for each point in the requirements review checklist. A requirements validation artificial intelligence (AI) engine is hosted by the at least one processor. The requirements validation AI engine is in operative communication with the set of databases. A large language model operatively communicates with the requirements validation AI engine, wherein the large language model is fine-tuned using datasets from one or more of the databases. A user interface is in operative communication with the requirements validation AI engine, with the user interface comprising a requirement input interface, and a reporting and visualization interface. A configuration management repository is in operative communication with the user interface and includes new requirements. The user interface is operative to send one or more user selected new requirements, from the configuration management repository, with one or more corresponding check instructions to the requirements validation AI engine. The requirements validation AI engine selects one or more prompts from the prompt database for review, based on types of one or more user selected new requirements and the one or more corresponding check instructions. The requirements validation AI engine sends the one or more prompts, and the one or more user selected new requirements, to the large language model to review for any defects in the one or more user selected new requirements. The large language model sends a response to the user interface, through the requirements validation AI engine, to report on validity of and any defects in the one or more user selected new requirements.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a block diagram of a system for implementing a software requirements completeness checker, according to one embodiment; and

FIG. 2 is a flow diagram of a method for implementing a software requirements completeness checker, according to one example.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A generative artificial intelligence (GenAI) assisted avionics system and software requirement completeness checker is described herein. The present approach provides for using a GenAI application that interfaces with a large language model (LLM), optimized and trained for understanding the complications and intricacies of regulatory guidelines, such as the DO-178C guidelines for avionics software requirements. The present approach enhances the efficiency, accuracy, and consistency of the requirement review process by automatically analyzing various aspects of software requirements.

The present system integrates advanced natural language processing to understand context, interpret the nuanced language of requirements, and evaluate interdependencies, providing a more thorough and sophisticated analysis. The system uses requirements standards, a review checklist, regulatory guidelines for requirements, historical requirements issues data, compliance audit data, and the like, for the requirement review process.

The present system provides a solution to the inherent limitations of human cognitive biases and error rates in requirement reviews, and supports the increasing complexity of software development. The present method offers higher accuracy in detecting incomplete requirements and identifying discrepancies, reducing the likelihood of costly errors, and can also process vast amounts of data rapidly, far beyond human capability. This method will provide significant cost savings and cycle time reduction by preventing overruns due to missed or incomplete requirements, and has the performance advantage of having the ability to provide early error detection, thus streamlining the software development process.

The GenAI LLM used in the present system complements human expertise by providing deep, consistent, and comprehensive analyses, to ensure a more thorough and effective validation of software requirements. The present technique can be employed to review system and software requirements in various aerospace applications, as well as in other non-aerospace applications, and can be customized for program specific data if needed.

### Software Requirements Review

There are various aspects of software requirements that are reviewed from a technical perspective. These include: completeness—the requirements must cover all of the functionality that the software must provide; consistency—the requirements must be consistent with each other and with the system requirements; unambiguousness—the requirements must be clear and unambiguous, so that there is no confusion about what they mean; feasibility—the requirements must be feasible to implement in the given time and budget; traceability—the requirements must be traceable to the system requirements, so that it is clear how each requirement is derived from a system requirement; safety—the requirements must meet the safety requirements for the software; testability—the requirements must be testable, so that it is possible to verify that the software meets the requirements; and maintainability—the requirements must be maintainable, so that they can be easily updated as needed.

Additional aspects of software requirements that are reviewed from a technical perspective include: check for mutual exclusive requirements—the requirements must not be mutually exclusive, meaning that they should not conflict with each other; performance—the software high level requirements must define the performance requirements for the software, such as response time, throughput, and memory usage; safety—the software high level requirements must define the safety requirements for the software, such as the ability to prevent or mitigate failures; reliability—the software high level requirements must define the reliability requirements for the software, such as the mean time to failure; and usability—the software high level requirements must define the usability requirements for the software, such as the ease of use and the ability to be operated by the intended users.

The manual review of software requirements for completeness and interdependencies is challenging due to the following issues: volume-requirement documents can be extensive, making it difficult to maintain a mental model of all requirements; complexity-requirements often contain technical language and nuanced details that can be misinterpreted or overlooked; subjectivity-different reviewers may interpret requirements differently, leading to inconsistent analyses; and interdependencies—understanding how one requirement impacts another requires a deep understanding of the entire system. It should be noted that manual review of software requirements is not limited to the foregoing issues, as these are just a few examples.

In one example, with respect to inter-system dependencies, assume the following requirements: “the flight control system shall respond to pilot inputs within 100 milliseconds” and “the data from the airspeed sensor shall be refreshed every 200 milliseconds.” There is a potential issue here in that the flight control system's requirement to respond quickly might be constrained by the slower refresh rate of the airspeed sensor data. This interdependency requires synchronization between the sensor's data refresh rate and the control system's response time to ensure coherent system performance. Given that the volume of requirements is huge, understanding how one requirement impacts another requires a deep understanding of the entire system, which very difficult for human review.

The present requirement completeness checker system and method provide various advantages and features that overcome the difficulties in prior approaches to software requirements review. For example, the present method provides a holistic review approach by analyzing multiple aspects of the requirements, from safety to usability, thereby providing a comprehensive review, ensuring no aspect of the review is overlooked. A fine-tuned AI model utilized in the present system can be specialized for a given sent of requirements, such as avionics software requirements, ensuring a tailored and precise analysis. The AI model provides for continuous learning, in that the system's ability to learn from historical issues and user feedback will make it more accurate and efficient over time. In addition, predictive analysis is provided in that the integration of historical data means the present system not only identifies current issues, but will predict potential future problems based on patterns.

The present system learns from historical requirements defects and compliance audit data, such as by incorporating learning from each compliance audit. This continuous learning approach ensures that the system adapts to evolving standards and incorporates insights from past reviews to refine and improve its requirement analysis methods. As the solution encounters a diverse range of audit outcomes and reviewer feedback, the AI model trains its algorithms to recognize a broader spectrum of compliance issues, further enhancing its capability to review requirements effectively. The present system also has a user-centric design, in which emphasis on actionable reports and a user feedback mechanism ensures the system is not just technologically advanced but also user-friendly.

The present system includes integrated compliance checking, such as direct integration of avionics regulatory guidelines (e.g., DO-178C guidelines). This ensures that the system is aligned with the most critical and updated standards, such as for the avionics industry. The present system can also include integrated compliance checking with customized requirements standards as well.

Further details of various embodiments are described hereafter and with reference to the drawings.

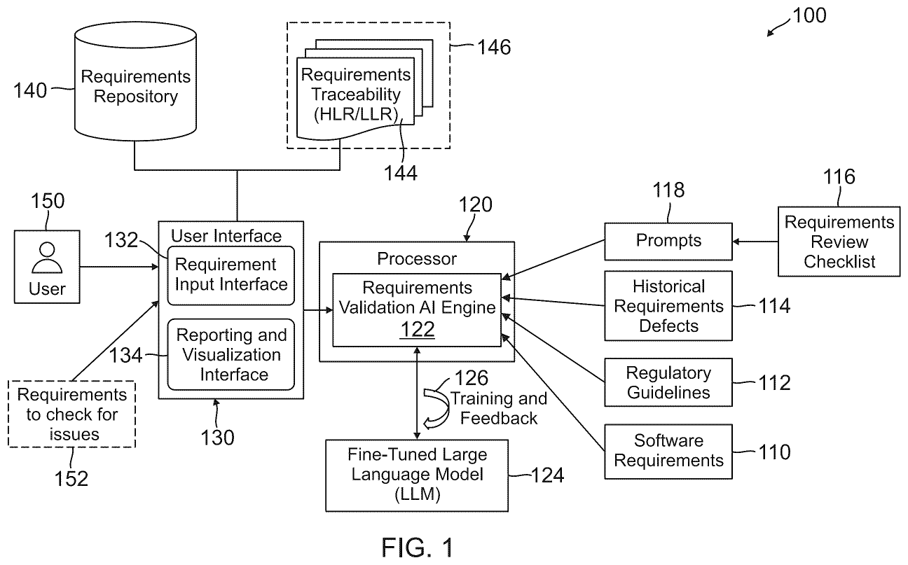

FIG. 1 is a block diagram of a system 100 for implementing a software requirements completeness checker, according to one embodiment. The system 100 comprises a set of databases that include a software requirements database 110, a regulatory guidelines database 112, and a historical requirements defects database 114. In addition, a requirements review checklist database 116 operatively communicates with a prompts database 118, which includes a respective prompt for each point in the requirements review checklist database 116. The system 100 further includes at least one processor 120, which is in operative communication with the various databases.

The system 100 further includes a requirements validation artificial intelligence (AI) engine 122 hosted by processor 120, with the requirements validation AI engine 122 operative to receive datasets from various of databases. A large language model (LLM) 124 operatively communicates with the requirements validation AI engine 122. The LLM 124 can be fine-tuned using datasets from one or more of the databases.

In one embodiment, LLM 124 can be “fine-tuned” by taking a pre-trained general-purpose model and further training this model on specific datasets to refine its capabilities and improve performance in a particular task or domain, such as turning the general-purpose model into a specialized model for software requirements review.

A user interface 130 is in operative communication with the requirements validation AI engine 122. The user interface 130 comprises a requirement input interface 132, and a reporting and visualization interface 134. A requirements repository 140 (e.g., in configuration management) is in operative communication with user interface 130 and includes new requirements. The user interface 130 is also operative to receive one or more requirements traceability files 144 such as from a requirements traceability database 146. The traceability files 144 include high level requirements (HLR) and low level requirements (LLR).

In one embodiment, the software requirements used in system 100 are applicable to an avionics software implementation for an aircraft, and the regulatory guidelines include a set of DO-178C guidelines.

The system 100 is operative to train a requirements validation AI model included in LLM 124 based on a dataset comprising historical requirements and associated defects, such as provided by historical requirements defects database 114. For example, LLM 124 can be trained using historical requirements defects database 114 to identify common pitfalls or mistakes. The LLM 124 validates the requirements against the historical requirements defects, and provides predictive warnings or alerts about potential issues based on past data. In addition, LLM 124 is trained with the requirements review checklist database 116 and its review criteria against each of the checklist points.

A training and feedback loop 126 between LLM 124 and requirements validation AI engine 122 can be provided to continuously improve system 100 by learning from reviewed requirements and user feedback. The inputs for training and feedback loop 126 include user feedback, verified issues, and updated guidelines. The outputs for training and feedback loop 126 include updated and improved model parameters.

As mentioned above, user interface 130 includes requirement input interface 132, and reporting and visualization interface 134. The requirement input interface 132 can be implemented with a front-end application, which provides an interface for a user to send requirements to the requirements validation AI engine 122, and offers options to fine-tune the AI model. In one embodiment, requirement input interface 132 can be integrated with requirements repository 140 in configuration management.

The reporting and visualization interface 134 has the function of presenting the results of requirement analysis in a user-friendly format. The reporting and visualization interface 134 provides a summary of the requirements, their status in terms of compliance with review checklist points, highlights issues detected within the requirements, and identifies any specific patterns or trends in the types of requirements that may require attention. The inputs for reporting and visualization interface 134 include reports from analysis modules, and the outputs include comprehensive, visual, and actionable reports for end-users.

A user feedback mechanism can be implemented that allows users to provide feedback on false positives/negatives to further train system 100. The inputs for the user feedback mechanism include user feedback on analyses performed by system 100, and the outputs include feedback data for training and feedback loop 126.

The requirements checked by system 100 include software high-level and low-level requirements, as well as system requirements, which need to be validated against a set of checklist points. For example, a check can be done to determine if a requirement is complete, consistent, and unambiguous according to regulatory guidelines, such as the DO-178C guidelines.

The system 100 is operative to generate an issue or defect with a requirement, and provide one or more suggested changes to the requirement based on identified defects and the trained AI model. The system 100 is operative to identify any inconsistencies between system requirements, software high level requirements and software low level requirements, using traceability data. The system 100 can generate one or more prompts and recommendations tailored to a specific expertise or role of a reviewer or user 150, and can display the one or more prompts and recommendations on user interface 130.

The requirements validation AI engine 122 and LLM 124 perform the following functions. The AI engine 122 constructs a prompt for each of the checkpoints presented in the requirements review checklist to validate a requirement; and sends the constructed prompt and the actual requirement text to LLM 124 for processing. The LLM 124 validates the requirements against the given checklist point using the prompt and responds with the requirement validation status, that is, if the requirement has passed the review or if there are any issues. If there are any issues, LLM 124 reports the details of the deficiency in the requirement. Examples of these functions are set forth hereafter with respect to different types of requirement issues.

During operation of system 100, the user interface 130 sends one or more user selected new requirements, from requirements repository 140, with one or more corresponding check instructions related to requirements to check for issues (from block 152), to the requirements validation AI engine 122. The requirements validation AI engine 122 selects one or more prompts from prompts database 118 for review, based on the types of received user selected new requirements and the corresponding instructions. The requirements validation AI engine 122 then sends the one or more prompts, and the one or more user selected new requirements, to LLM 124 to review for any defects in the user selected new requirements. The LLM 124 sends a response to user interface 130, through the requirements validation AI engine 122, to report on validity of and any defects in the user selected new requirements.

### Requirements Completeness Checker

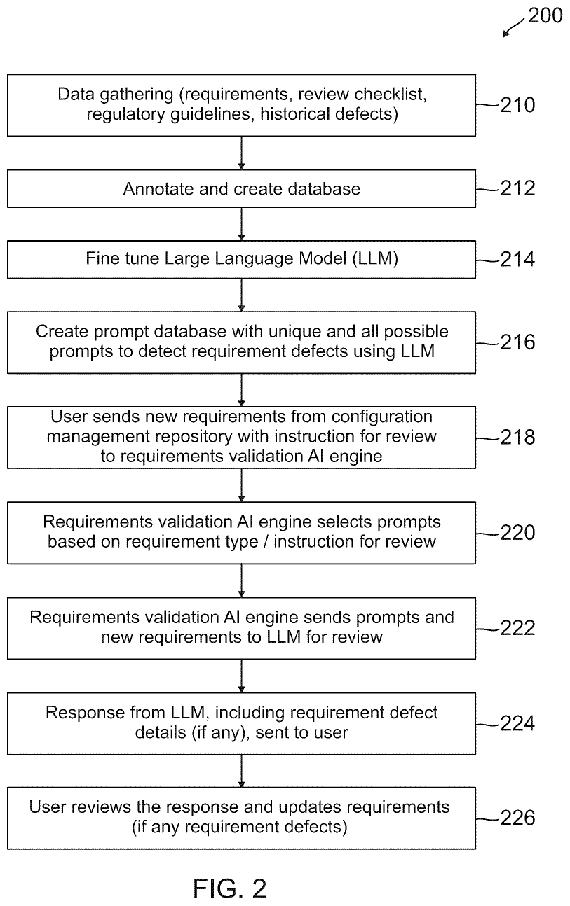

FIG. 2 is a flow diagram of a method 200 for implementing a software requirements completeness checker, according to one example. Initially, method 200 comprises performing data gathering, including gathering of requirements (e.g., requirements standards), a review checklist, regulatory guidelines, and historical defects (block 210). Next, method 200 annotates and creates at least one database (block 212), which can include previously reported defects for the requirements during a review; a corrected requirement addressing a defect and/or reason for not implementing the defect, or classified as a non-defect; parts of a requirement, for example, input part, output part, desired function, or type of requirement; classification including, but not limited to, built-in test requirement, functional, range of the system, color or appearance of an object (for visual functionality). The functions can vary from design to entire integration. Annotation is a logical start/end of a requirement or a requirement type, or in simple terms, explaining to the generative AI system what each sub-chunk or sub-section of a requirement means. The method 200 then fine tunes a large language model (LLM) (block 214), and creates a prompt database with unique and all possible prompts to detect requirement defects using the LLM (block 216).

Thereafter, a user sends one or more new requirements from a configuration management repository, with instruction for review, to a requirements validation AI engine (block 218). The one or more new requirements can be include an individual requirement, a group of requirements, or a software requirements specification (SRS) document. The requirements validation AI engine selects prompts based on the requirement type and instruction for review (block 220). The requirements validation AI engine then sends the prompts and new requirements to the LLM for review (block 222). A response from the LLM, including requirement defect details, if any, is sent to the user (block 224). The user then reviews the response and updates the requirements if there are any requirement defects (block 226).

The following sections describe various example functions that can be performed by the present approach, and include representative requirements of different requirement type/category. The requirements issues in these examples were introduced by design and validated through the present methods.

### Mutually Exclusive/Conflicting Logic

With respect to mutually exclusive and conflicting logic, the following example prompt and response were generated.

```
Prompt:
  AA-BBB-78:
  Resolution: 0.001 knots for speed.
  IF Altitude is greater than 200.0 feet and less than or equal to 1000.0
  feet and speed is greater than 100 knots then
    AAAA Phase is TOFP
  ELSE IF Altitude is greater than 1000.0 feet and less than or equal
  1500.0 feet and speed is greater than 120 knots then
    AAAA Phase is CLFP
  ELSE IF Altitude is greater than 1499.0 feet and speed is greater than
  250.0 knots then
    AAAA Phase is CFP
  END IF
  Are all conditions in above requirements mutually exclusive? Explain
  clearly with respect to output.
Response from AI:
  No, all conditions in above requirement are not mutually exclusive.
  The conditions are not mutually exclusive.
  The condition “Altitude is greater than 1000.0 feet and less than or equal
  1500.0 feet and speed is greater than 120.0 knots” is covered in both
  “Altitude is greater than 1000.0 feet and less than or equal 1500.0 feet
  and speed is greater than 120.0 knots” and “Altitude is greater than
  1499.0 feet and speed is greater than 250.0 knots”.
```

### Mutually Exclusive and Completeness in Multiple Requirements

With respect to mutually exclusive and completeness in multiple requirements, the following example prompts and responses were generated.

```
Prompt:
  AA-BBB-81:
  AAAA_PHASE4 is an enum with values: TOFP, CLFP, CFP
  IF ALTITUDE4 is greater than 800.0 feet and less than 1500.0 feet and
  SPEED4 is greater than 120 knots then
    AAAA_PHASE4 is TOFP
  END IF
  AA-BBB-82:
  IF ALTITUDE4 is greater than 1400.0 feet and less than 2000.0 feet and
  SPEED4 is greater than 120 knots then
    AAAA_PHASE4 is CLFP
  END IF
  Are requirements AA-BBB-81 and AA-BBB-82 mutually exclusive?
  Explain.
Response from AI:
  No, requirements AA-BBB-81 and AA-BBB-82 are not mutually
  exclusive.
  The condition “ALTITUDE4 is greater than 1400.0 feet and less than
  2000.0 feet and SPEED4 is greater than 120 knots” is covered in both
  “ALTITUDE4 is greater than 800.0 feet and less than 1500.0 feet and
  SPEED4 is greater than 120 knots” and “ALTITUDE4 is greater than
  1400.0 feet and less than 2000.0 feet and SPEED4 is greater than 120
  knots”.
Prompt:
  Are requirements AA-BBB-81 and AA-BBB-82 complete? Explain.
Response from AI:
  No, requirements AA-BBB-81 and AA-BBB-82 are not complete.
  The requirements are not complete. They do not cover the case when
  ALTITUDE4 is less than or equal to 800.0 feet.
  The requirements are not complete. They do not cover the case when
  ALTITUDE4 is greater than or equal to 2000.0 feet.
  The requirements are not complete. They do not cover the case when
  SPEED4 is less than or equal to 120 knots.
```

### Variable Name Range, Tolerance Checks for Requirement

With respect to variable name range, and tolerance checks for requirement, the following example prompts and responses were generated.
Prompt:
   ICD Signal table 1 is given below:

| Variable Name | Range | Tolerance | Default | Data Type |
|---|---|---|---|---|
| g_Cabin_Temperature | 60-100 | | 0.0 | Float |
| g_Altitude | 0.0-45000.0 | 0.1 | 0 | Float |
| g_Flight_Phase | Taxi, Takeoff, Climb, | | Taxi | Enum |
| | Cruise, Descent, Approach | | | |
| g_Engine_Temperture | | 0.5 | 0.0 | Float |

Validate the variable names for which the range or tolerance or default is not defined, ignore tolerance for enum data type.
Response from AI:
The variable g_Cabin_Temperature has a range defined as 60-100 degrees Fahrenheit, but does not have a tolerance defined in the ICD Signal table 1.
The variable g_Engine_Temperture does not have a range defined in the ICD Signal table 1, but has a tolerance of 0.5 defined.
Note that g_Flight_Phase is an enumeration and does not have a range or tolerance defined in the table, but has a default value of Taxi defined. However, g_Altitude has a range of 0.0-45000.0 feet and a tolerance of 0.1 defined in the table, and also has a default value of 0 defined.

### Ambiguous and Redundant Requirements

With respect to an ambiguous requirement, the following example prompt and response was generated.

```
Prompt:
  //AA-BBB-91:
  /*
  IF XXX is greater than YYY by some value
  THEN
    ZZZ = TRUE
  ELSE
  ZZZ = FALSE
  END IF
  */
  Is requirement AA-BBB-91 having clarity issue? Explain.
Response from AI:
  Yes, requirement AA-BBB-91 is having clarity issue.
  The requirement is not clear about the value by which XXX is greater
  than YYY.
```

With respect to redundant requirements, the following example prompt and response was generated.

```
Prompt:
  AA-BBB-71:
  IF (XXX > VTHR − XX)
  THEN
    ABC = TRUE
  ELSE
    ABC = FALSE
  END IF
  AA-BBB-72:
  IF (XXX > VTHR − XX)
  THEN
    ABC = TRUE
  ELSE
    ABC = FALSE
  END IF
  Are requirements AA-BBB-71 and AA-BBB-72 having duplicate logic?
  Explain.
Response from AI:
  Yes, requirements AA-BBB-71 and AA-BBB-72 are having duplicate
  logic.
  Both requirements are checking if XXX is greater than VTHR − XX.
```

### Timing Requirement Tolerance

With respect to timing requirement tolerance, the following example prompt and response was generated.
Prompt:
   AA-BBB-97: Timing requirement
   IF the controller is not reset by the watch dog in less than 50 us, then set the watchdog flag to TRUE.
   Is requirement AA-BBB-97 having tolerance defined for time interval? Explain.
Response from AI:
   The requirement AA-BBB-97 does not have a tolerance defined for the time interval of 50 microseconds.
   A tolerance specifies the acceptable deviation from a specified value or range, and is typically used to account for variations in the system or measurement errors.
   In this case, the requirement specifies that the watchdog must not reset the controller in less than 50 microseconds, but does not specify any tolerance for this time interval.
   Therefore, the requirement AA-BBB-97 does not have a tolerance defined for the time interval of 50 microseconds.

### Untestable/Dead Logic

With respect to untestable/dead logic, the following example prompt and response was generated.

```
Prompt:
  AA-BBB-75:
  IF (YYY > THRES)
  THEN
    Operating_Mode = OP_MODE1
  ELSE IF (YYY = THRES)
    Operating_Mode = OP_MODE2
  ELSE if (YYY > THRES)
    Operating_Mode = OP_MODE3
  ELSE if (YYY < THRES)
    Operating_Mode = OP_MODE4
  END IF
  Is there any dead logic in requirement AA-BBB-75? List the dead
  logic.
Response from AI:
  Yes, there is dead logic in requirement AA-BBB-75.
  The dead logic is checking if YYY is greater than THRES and then
  checking if YYY is greater than THRES again.
```

### Design For Testability

With respect to design for testability, the following example prompt and response was generated.
Prompt:
   Design for testability Rule: All the variables referred in requirements must be global variables
   AA-BBB-99a: status_register_2 is a local variable of type uint8_t in a function.
   When Poweron builtin test fault is set, the system shall set the bit 7 of status_register_2 to 0.
   Is the requirement comply with design for testability rule?
Response from AI:
   No, the requirement does not comply with the design for testability rule. The variable status_register_2 is a local variable and not a global variable. To comply with the design for testability rule, status_register_2 should be a global variable.

The processing units and/or other computational devices used in the system and method described herein may be implemented using software, firmware, hardware, or appropriate combinations thereof. The processing units and/or other computational devices may be supplemented by, or incorporated in, specially-designed application-specific integrated circuits (ASICs) or field programmable gate arrays (FPGAs). The processing units and/or other computational devices can also include or function with software programs, firmware, or other computer readable instructions for carrying out various process tasks, calculations, and control functions used in the methods and systems described herein.

The methods described herein may be implemented by computer executable instructions, such as program modules or components, which are executed by at least one processor or processing unit. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer readable instructions. These instructions are typically stored on appropriate computer program products that include computer readable media used for storage of computer readable instructions or data structures. Such a computer readable medium may be available media that can be accessed by a general purpose or special purpose computer or processor, or any programmable logic device.

Suitable computer readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer executable instructions or data structures.

### Example Embodiments

Example 1 includes a system comprising: at least one processor; a set of databases in operative communication with the at least one processor, the set of databases comprising a software requirements database, a regulatory guidelines database, a historical requirements defects database, a requirements review checklist database, and a prompt database that includes a respective prompt for each point in the requirements review checklist; a requirements validation artificial intelligence (AI) engine hosted by the at least one processor, the requirements validation AI engine in operative communication with the set of databases; a large language model that operatively communicates with the requirements validation AI engine, wherein the large language model is fine-tuned using datasets from one or more of the databases; a user interface in operative communication with the requirements validation AI engine, the user interface comprising a requirement input interface, and a reporting and visualization interface; and a configuration management repository in operative communication with the user interface, the configuration management repository including new requirements; wherein the user interface is operative to send one or more user selected new requirements, from the configuration management repository, with one or more corresponding check instructions to the requirements validation AI engine; wherein the requirements validation AI engine selects one or more prompts from the prompt database for review, based on types of one or more user selected new requirements and the one or more corresponding check instructions; wherein the requirements validation AI engine sends the one or more prompts, and the one or more user selected new requirements, to the large language model to review for any defects in the one or more user selected new requirements; wherein the large language model sends a response to the user interface, through the requirements validation AI engine, to report on validity of and any defects in the one or more user selected new requirements.

Example 2 includes the system of Example 1, further comprising: a requirements traceability database in operative communication with the user interface, the requirements traceability database including high level requirements and low level requirements.

Example 3 includes the system of Example 2, wherein the system is operative to identify any inconsistencies between system requirements, software high level requirements and software low level requirements, using traceability data from the requirements traceability database.

Example 4 includes the system of any of Examples 1-3, wherein: the software requirements are applicable to an avionics software implementation for an aircraft; and the regulatory guidelines include a set of DO-178C guidelines.

Example 5 includes the system of any of Examples 1-4, wherein the system is operative to train a requirements validation AI model on a dataset comprising historical requirements and associated defects.

Example 6 includes the system of Example 5, wherein the system is operative to generate an issue or defect with a requirement, and provide one or more suggested changes to the requirement based on identified defects and the trained AI model.

Example 7 includes the system of any of Examples 1-6, wherein the system is operative to: generate one or more prompts and recommendations tailored to a specific expertise or role of a user; and display the one or more prompts and recommendations on the user interface.

Example 8 includes the system of any of Examples 1-7, wherein the requirements validation AI engine is operative to: construct a prompt for each checkpoint present in a requirements review checklist to validate a requirement; and send the constructed prompt and text of the requirement to the large language model for analysis.

Example 9 includes the system of Example 8, wherein the large language model is operative to validate the requirement against the checkpoint of the prompt, and respond to the requirements validation AI engine with a requirement validation status.

Example 10 includes a method comprising: creating a set of databases including software requirements, a requirements review checklist, regulatory guidelines, historical requirements defects, and requirements standards; creating a prompt database that includes a respective prompt for each point in the requirements review checklist; providing a requirements validation artificial intelligence (AI) engine that operatively communicates with the set of databases and the prompt database; providing a fine-tuned large language model (LLM) that operatively communicates with the requirements validation AI engine; and sending one or more user selected new requirements, from a configuration management repository, with one or more corresponding instructions to the requirements validation AI engine; wherein the requirements validation AI engine performs a process comprising: selecting one or more prompts from the prompt database for review, based on types of one or more user selected new requirements and the one or more corresponding instructions; and sending the one or more prompts, and the one or more user selected new requirements, to the large language model to review for any defects in the new requirements; wherein the large language model sends a response to a user interface, through the requirements validation AI engine, to report on validity and any defects of the one or more user selected new requirements.

Example 11 includes the method of Example 10, wherein a requirements traceability database operatively communicates with the user interface, the requirements traceability database including high level requirements and low level requirements.

Example 12 includes the method of Example 11, further comprising identifying any inconsistencies between system requirements, the high level requirements and the low level requirements, using traceability data from the requirements traceability database.

Example 13 includes the method of any of Examples 10-12, wherein: the software requirements are applicable to an avionics software implementation for an aircraft; and the regulatory guidelines include a set of DO-178C guidelines.

Example 14 includes the method of any of Examples 10-13, further comprising training the large language model with a dataset comprising the historical requirements defects.

Example 15 includes the method of any of Examples 10-14, wherein the requirements validation AI engine sends one or more suggested changes to a requirement under review to the user interface, based on one or more identified defects in the requirement.

Example 16 includes the method of any of Examples 10-15, further comprising: generating one or more prompts and recommendations tailored to a specific expertise or role of a user; and displaying the one or more prompts and recommendations on the user interface.

Example 17 includes the method of any of Examples 10-16, wherein the requirements validation AI engine further performs a process comprising: constructing a prompt for each checkpoint present in a requirements review checklist to validate a requirement; and sending the constructed prompt and text of the requirement to the large language model for analysis.

Example 18 includes the method of Example 17, wherein the large language model validates the requirement against the checkpoint of the prompt, and responds to the requirements validation AI engine with a requirement validation status.

Example 19 includes the method of any of Examples 10-18, wherein the one or more user selected new requirements include an individual requirement, a group of requirements, or a software requirements specification (SRS) document.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A system comprising:
at least one processor;
a set of databases in operative communication with the at least one processor, the set of databases comprising a software requirements database, a regulatory guidelines database, a historical requirements defects database, a requirements review checklist database, and a prompt database that includes a respective prompt for each point in the requirements review checklist;
a requirements validation artificial intelligence (AI) engine hosted by the at least one processor, the requirements validation AI engine in operative communication with the set of databases;
a large language model that operatively communicates with the requirements validation AI engine, wherein the large language model is fine-tuned using datasets from one or more of the databases;
a user interface in operative communication with the requirements validation AI engine, the user interface comprising a requirement input interface, and a reporting and visualization interface; and
a configuration management repository in operative communication with the user interface, the configuration management repository including new requirements;
wherein the user interface is operative to send one or more user selected new requirements, from the configuration management repository, with one or more corresponding check instructions to the requirements validation AI engine;
wherein the requirements validation AI engine selects one or more prompts from the prompt database for review, based on types of one or more user selected new requirements and the one or more corresponding check instructions;
wherein the requirements validation AI engine sends the one or more prompts, and the one or more user selected new requirements, to the large language model to review for any defects in the one or more user selected new requirements;
wherein the large language model sends a response to the user interface, through the requirements validation AI engine, to report on validity of and any defects in the one or more user selected new requirements.

2. The system of claim 1, further comprising:
a requirements traceability database in operative communication with the user interface, the requirements traceability database including high level requirements and low level requirements.

3. The system of claim 2, wherein the system is operative to identify any inconsistencies between system requirements, software high level requirements and software low level requirements, using traceability data from the requirements traceability database.

4. The system of claim 1, wherein:
the software requirements are applicable to an avionics software implementation for an aircraft; and
the regulatory guidelines include a set of DO-178C guidelines.

5. The system of claim 1, wherein the system is operative to train a requirements validation AI model on a dataset comprising historical requirements and associated defects.

6. The system of claim 5, wherein the system is operative to generate an issue or defect with a requirement, and provide one or more suggested changes to the requirement based on identified defects and the trained AI model.

7. The system of claim 1, wherein the system is operative to:
generate one or more prompts and recommendations tailored to a specific expertise or role of a user; and
display the one or more prompts and recommendations on the user interface.

8. The system of claim 1, wherein the requirements validation AI engine is operative to:
construct a prompt for each checkpoint present in a requirements review checklist to validate a requirement; and
send the constructed prompt and text of the requirement to the large language model for analysis.

9. The system of claim 8, wherein the large language model is operative to validate the requirement against the checkpoint of the prompt, and respond to the requirements validation AI engine with a requirement validation status.

10. A method comprising:
creating a set of databases including software requirements, a requirements review checklist, regulatory guidelines, historical requirements defects, and requirements standards;
creating a prompt database that includes a respective prompt for each point in the requirements review checklist;
providing a requirements validation artificial intelligence (AI) engine that operatively communicates with the set of databases and the prompt database;
providing a fine-tuned large language model (LLM) that operatively communicates with the requirements validation AI engine; and
sending one or more user selected new requirements, from a configuration management repository, with one or more corresponding instructions to the requirements validation AI engine;
wherein the requirements validation AI engine performs a process comprising:
selecting one or more prompts from the prompt database for review, based on types of one or more user selected new requirements and the one or more corresponding instructions; and
sending the one or more prompts, and the one or more user selected new requirements, to the large language model to review for any defects in the new requirements;
wherein the large language model sends a response to a user interface, through the requirements validation AI engine, to report on validity and any defects of the one or more user selected new requirements.

11. The method of claim 10, wherein a requirements traceability database operatively communicates with the user interface, the requirements traceability database including high level requirements and low level requirements.

12. The method of claim 11, further comprising identifying any inconsistencies between system requirements, the high level requirements and the low level requirements, using traceability data from the requirements traceability database.

13. The method of claim 10, wherein:
the software requirements are applicable to an avionics software implementation for an aircraft; and
the regulatory guidelines include a set of DO-178C guidelines.

14. The method of claim 10, further comprising training the large language model with a dataset comprising the historical requirements defects.

15. The method of claim 10, wherein the requirements validation AI engine sends one or more suggested changes to a requirement under review to the user interface, based on one or more identified defects in the requirement.

16. The method of claim 10, further comprising:
generating one or more prompts and recommendations tailored to a specific expertise or role of a user; and
displaying the one or more prompts and recommendations on the user interface.

17. The method of claim 10, wherein the requirements validation AI engine further performs a process comprising:
constructing a prompt for each checkpoint present in a requirements review checklist to validate a requirement; and
sending the constructed prompt and text of the requirement to the large language model for analysis.

18. The method of claim 17, wherein the large language model validates the requirement against the checkpoint of the prompt, and responds to the requirements validation AI engine with a requirement validation status.

19. The method of claim 10, wherein the one or more user selected new requirements include an individual requirement, a group of requirements, or a software requirements specification (SRS) document.
